(19) United States
(12) Patent Application Publication
(10) Pub. No.: US 2004/0258873 A1
(43) Pub. Date: Dec. 23, 2004

(54) Flexible magnetic disc medium

(75) Inventors: Kazuyuki Usuki, Kanagawa (JP); Kenichi Moriwaki, Kanagawa (JP); Shinji Saito, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/862,315

(22) Filed: Jun. 8, 2004

(30) Foreign Application Priority Data
Jun. 9, 2003 (JP) P.2003-163872

(51) Int. Cl. G11B 5/52

(52) U.S. Cl. 428/65.3; 428/694 T

(57) ABSTRACT

A magnetic disc medium comprising a flexible polymer support and a magnetic layer containing a ferromagnetic metal, wherein a ten point average roughness of a surface of the flexible magnetic disc medium of a side having the magnetic layer measured with an atomic force microscope is from 15 to 40 nm, and a number of projections present at a height from a reference plane of 10 nm on the surface is from 0.1 to 10/μm².

### FIELD OF THE INVENTION

The present invention relates to a flexible magnetic disc medium for use in the recording of digital information recording.

### BACKGROUND OF THE INVENTION

With the spread of the Internet in recent years, the use form of the computer has been changed, e.g., to the form of processing a great volume of motion picture data and sound data with a personal computer. Along with these trends, the storage capacity required of the magnetic recording media, such as hard discs, has increased.

In a hard disc apparatus, a magnetic head slightly floats from the surface of a magnetic disc with the rotation of the magnetic disc, and magnetic recording is done by non-contact recording system. This mechanism prevents the magnetic disc from breaking by the touch of the magnetic head and the magnetic disc. With the increase of density of magnetic recording, the flying height of a magnetic head is gradually decreased, and now the flying height of from 10 to 20 nm has been realized by the use of a magnetic disc comprising a specularly polished hyper-smooth glass substrate having provided there on a magnetic recording layer. A real recording density and recording capacity of hard disc drive have markedly increased during the past few years by technological innovation, e.g., the flying height reduction of a head, the improvement of the structure of a head, and the improvement of the recording film of a disc.

With the increase of throughput of digital data, there arises a need of moving a high capacity data, such as moving data, by recording on a removable medium. However, since the substrate of a hard disc is made of a hard material and the distance between a head and a disc is extremely narrow as described above, there is the fear of happening of accident by the impact during operation and entraining dusts when a hard disc is tried to be used as a removable medium such as a flexible disc and a rewritable optical disc, and so a hard disc cannot be used.

In direct read after write and rewritable type optical discs typified by DVD-R and DVD-RW, the head and the disc are not close to each other as in a magnetic disc, therefore they are excellent in removability and widespread. However, from the thickness of light pickup and economical viewpoints, it is difficult for optical discs to take such a disc structure that both surfaces can be used as recording surfaces as in a magnetic disc, which is advantageous for increasing capacity. Further, optical discs are low in a real recording density and also in data transfer rate as compared with magnetic discs, and so their performance is not sufficient yet as rewritable high capacity recording media. Further, the structure of light pickup of optical discs is complicated, so that the miniaturization of the drive is difficult.

Smart media with built-in semiconductor memories have been now the mainstream as the recording media for digital cameras and digital video recorders, but the costs to the storage capacity of these semiconductor memory media are remarkably high as compared with other magnetic and optical disc media as described above, so that it is difficult to reconcile the increment of capacity with the reduction of price.

On the other hand, since the substrates of flexible magnetic discs are flexible, they are excellent in removability. However, now commercially available flexible magnetic discs have the structure having recording layers formed by coating magnetic powder and a polymer binder on a polymer film. Therefore, as compared with hard discs having a magnetic layer formed by sputtering, flexible magnetic discs are inferior in high density recording characteristics, and the achieved recording density of flexible magnetic discs is only 1/10 or less of that of hard discs.

JP-A-2001-101648 (The term “JP-A” as used herein refers to an “unexamined published Japanese patent application”.) discloses a flexible magnetic disc comprising a polymer film having provided thereon a ferromagnetic metal thin film, and the metal thin film has minute spines (projections) having a diameter of from 30 to 200 nm and a height of from 10 to 70 nm in the density of from 1 to 100 per μm². JP-A-2001-101648 also discloses the system of recording and reproducing the signals of a track width of 2.2 μm and a linear recording density of 100 kFCI by an MR head with the rotation of 2,000 rpm or more.

However, the demand for the higher density in recent years is high, and further narrowing track width and increasing linear recording density are required.

However, high capacity and rewritable flexible magnetic disc media satisfying these high requirements of the performance, reliability and cost are not present yet, although the requirements are high.

### SUMMARY OF THE INVENTION

An object of the present invention is to provide a flexible magnetic disc medium capable of designing a system using a low abrasion resistant and high sensitivity head such as an MR head and a GMR head, having high performance and high reliability, and using inexpensive ferromagnetic metal thin film as the magnetic layer.

The above object of the invention can be achieved by a flexible magnetic disc medium comprising a flexible polymer support and a magnetic layer comprising a ferromagnetic metal thin film provided at least on one side of the support, wherein the ten point average roughness (Rz) of the surface of the medium of the side having the magnetic layer (in which the support, the magnetic layer and the surface are in this order) measured with an atomic force microscope is from 15 to 40 nm, and the number of minute spines (projections) present at the height from the reference plane of 10 nm on the surface is from 0.1 to 10/μm².

### DETAILED DESCRIPTION OF THE INVENTION

Since a flexible polymer support is used as the support of the flexible magnetic disc medium (hereafter also referred to as merely “a magnetic disc”) in the present invention, the impact by the touch of a magnetic head and a magnetic disc is reduced, and a magnetic head and a magnetic disc are stably brought into contact and slide by the reduction of the real contact area due to the specific surface characteristics composed of very low spines, so that stable head running becomes possible. Further, in a recording system using an MR head and a GMR head that are low abrasion resistant and high sensitivity magnetic heads, long term operation is also possible without breaking the magnetic heads.

The mode for carrying out the invention is described in detail below.

The flexible magnetic disc according to the invention has a structure having a center hole formed in the central part, and is encased in a metal or plastic cartridge. The cartridge is generally provided with an access window covered with a metal shutter, and a magnetic head is introduced to the magnetic disc through the access window, thereby recording of signals on the magnetic disc and reproduction are performed.

The magnetic disc in the invention comprises a flexible disc-like polymer support having at least on one side of the support a magnetic layer comprising at least a ferromagnetic metal thin film, and preferably comprises in lamination in the order of an undercoat layer for improving a surface property and a gas-barrier property, an under layer for improving the magnetic characteristics of a magnetic layer, a magnetic layer, a protective layer for protecting the magnetic layer from corrosion and abrasion, and a lubricating layer for improving running durability and anticorrosion by imparting a lubricant.

For avoiding the impact by the touch of a magnetic head and a magnetic disc, a support is composed of a flexible resin film (a flexible polymer support). As such resin films, resin films comprising aromatic polyimide, aromatic polyamide, aromatic polyamideimide, polyether ketone, polyether sulfone, polyether imide, polysulfone, polyphenylene sulfide, polyethylene naphthalate, polyethylene terephthalate, polycarbonate, triacetate cellulose, and fluorine resin are exemplified. Polyethylene terephthalate and polyethylene naphthalate are particularly preferably used in the invention from the viewpoint of the cost and surface roughness, in case that good recording characteristics can be achieved without heating a substrate.

A lamination comprising a plurality of resin films may be used as a support. By using a laminated film, warp and waviness resulting from a support itself can be reduced, which conspicuously improve the scratch resistance of a magnetic recording layer during running.

As laminating methods, roll lamination by heat rollers, lamination by plate hot press, dry lamination of laminating by coating an adhesive on the adhesion surface, and lamination of using an adhesive sheet formed in advance in the form of a sheet are exemplified. The kinds of adhesives are not especially restricted and a general hot melt adhesive, a thermosetting adhesive, a UV-curable type adhesive, an EB-curable type adhesive, an adhesive sheet, and an anaerobic adhesive can be used.

The size of a support, i.e., the size of a magnetic disc, is from 20 to 150 mm, and the thickness is generally from 10 to 200 μm, preferably from 20 to 100 μm, and more preferably from 30 to 70 μm. When a support is thin, stability at the time of high velocity rotation lowers and run out increases. While when a support is thick, the rigidity at the time of rotation increases and it becomes difficult to avoid the impact due to the touch, which causes jumping of a magnetic head.

The nerve of a support is represented by the following equation, and the value of the nerve is preferably from 0.5 to 2.0 kgf/mm² (=about 4.9 to 19.6 MPa) when b is 10 mm, and more preferably from 0.7 to 1.5 kgf/mm² (=about 6.9 to 14.7 MPa).

Nerve of support=Ebd³/12

In the equation, E represents a Young's modulus, b represents a film breadth, and d represents a film thickness.

The surface of a support is preferably as smooth as possible for performing recording by a magnetic head. The unevenness of the surface of a support markedly degrades the recording and reproducing characteristics of signals. Specifically, when an undercoat layer described later is used, the surface roughness in centerline average surface roughness (Ra) measured with an optical surface roughness meter is 5 nm or less, preferably 2 nm or less, the height of spine measured with a feeler type roughness meter is 1 μm or less, preferably 0.1 μm or less, and the ten point average roughness (Rz) measured with an atomic force microscope (AFM) is 500 nm or less, preferably 200 nm or less. When an undercoat layer is not used, the surface roughness in center line average surface roughness (Ra) measured with an optical surface roughness meter is 3 nm or less, preferably 1 nm or less, the height of spine measured with a feeler type roughness meter is 0.1 μm or less, preferably 0.06μm or less, and the ten point average roughness (Rz) measured with AFM is 60 nm or less, preferably 30 nm or less.

It is preferred to provide an undercoat layer on the surface of a support for the purpose of improving a plane surface property and a gas-barrier property. For forming a magnetic layer by sputtering, it is preferred that an undercoat layer be excellent in heat resistance. As the materials of an undercoat layer, polyimide resins, polyamideimide resins, silicone resins and fluorine resins can be used. Thermosetting polyimide resins and thermosetting silicone resins have a high smoothing effect and particularly preferred. The thickness of an undercoat layer is preferably from 0.1 to 3.0 μm. When other resin films are laminated on a support, an undercoat layer may be formed before lamination processing, or may be formed after lamination processing.

As thermosetting polyimide resins, polyimide resins obtained by thermal polymerization of an imide monomer having two or more unsaturated terminal groups in the molecule, e.g., bisallylnadiimide (BANI manufactured by Maruzen Petrochemical Co., Ltd.) are preferably used. This imide monomer can be thermally polymerized at a relatively low temperature after being coated in the state of a monomer on the surface of a support, and so the material monomer can be directly coated on a support and cured. Further, this imide monomer can be used by being dissolved in ordinary solvents, is excellent in productivity and working efficiency, has a small molecular weight, and the solution of the imide monomer is low in viscosity, so that it gets into the unevenness well in coating and is excellent in smoothing effect.

As thermosetting silicone resins, silicone resins obtained by polymerization by a sol-gel method with silicone compounds having introduced an organic group as the starting material are preferably used. The silicone resins have a structure in which a part of the silicon dioxide bonds is substituted with an organic group, and the resins are greatly excellent in heat resistance as compared with silicone rubbers and more flexible than silicon dioxide films, therefore, cracking and peeling are hardly generated when a film of the silicone resins is formed on a support comprising a flexible film. In addition, since the starting material monomers can be directly coated on a support and hardened, general-purpose solvents can be used, the resins get into the unevenness well, and smoothing effect is high. Further, since condensation polymerization reaction advances from comparatively low temperature by the addition of a catalyst such as an acid and a chelating agent, hardening can be expedited, and a resin film can be formed with a general-purpose coating apparatus. Thermosetting silicone resins are excellent in a gas barrier property of shielding gases generating from a support when a magnetic layer is formed and hindering the crystallizability and orientation of the magnetic layer and the under layer, so that they can be particularly preferably used.

It is preferred to provide minute spines (texture) on the surface of an undercoat layer for the purpose of reducing the real contact area of a magnetic head and a magnetic disc and improving a tribological property. Furthermore, the handling property of a support can be improved by providing minute spines. As methods of forming minute spines, a method of coating spherical silica particles and a method of coating an emulsion to thereby form the spines of an organic substance can be used, and a method of coating spherical silica particles is preferred for ensuring the heat resistance of the undercoat layer.

The height of minute spines (the same meaning as the height of spines from the reference plane in the number of spines of the invention) is preferably from 5 to 25 nm, more preferably from 7 to 18 nm. When the height of spines is in this range, the spacing loss between the recording/reproducing heads and the medium becomes small and recording/reproducing characteristics of signals better. The density of minute spines that brings about the improving effect of a tribological property is preferably from 0.1 to 10/μm², and more preferably from 1 to 5/μm². The improving effect of a tribological property is great with this range of the density of minute spines, and recording/reproducing characteristics are improved by the reduction of high spines due to the decrease of agglomerated particles.

Minute spines can also be fixed on the surface of a support or on the surface of a smoothed undercoat layer with a binder. It is preferred to use resins having sufficient heat resistance as the binder. As the resins having heat resistance, solvent-soluble polyimide resins, thermosetting polyimide resins and thermosetting silicone resins are particularly preferably used.

It is preferred to provide a gas barrier layer between a support and an under layer described later for the purpose of shielding gases generating from a support or an undercoat layer. As the gas barrier layer, materials for a seed layer used for increasing crystal orientation of an under layer can also be used. As such a gas barrier layer, C, diamond-like carbon, Ni—P, Ni—Al, Ti, Au and alloys of them, Ag and alloys of Ag can be used.

It is preferred to provide an under layer between a support and a magnetic layer, or between a gas barrier layer and a magnetic layer. As the under layer, Cr, alloys of Cr with a metal selected from Ti, Si, W, Ta, Zr, Mo and Nb, and Ru can be exemplified. These materials may be used alone or two or more of these materials may be used in combination. Orientation of a magnetic layer can be improved by using these under layers, and so recording characteristics are improved. The thickness of an under layer is preferably from 10 to 200 nm, particularly preferably from 20 to 100 nm.

A magnetic layer may be a so-called perpendicular magnetic recording layer having the axis of easy magnetization in the perpendicular direction to the disc surface, or may be an in-plane magnetic recording layer that is predominant in the present hard discs. The direction of the axis of easy magnetization can be controlled by the materials and crystal structure of an under layer and the composition and film forming condition of a magnetic layer.

Ferromagnetic metal thin film can be used as a magnetic layer as described above, cobalt-containing ferromagnetic metal alloys are preferred, and a magnetic layer comprising a mixture of a cobalt-containing ferromagnetic metal alloy and a nonmagnetic oxide is particularly preferred. In this magnetic layer, a ferromagnetic metal alloy and a nonmagnetic oxide are mixed in a broad sense, but they take the structure that a nonmagnetic oxide covers ferromagnetic metal alloy fine particles in a narrow sense, and the particle size of ferromagnetic metal alloy particles is from 1 to 50 nm or so. High coercive force can be achieved by taking such a structure and the variation of magnetic particles becomes uniform, so that a low noise medium can be obtained.

As cobalt-containing ferromagnetic metal alloys, alloys comprising Co and Cr. Ni, Fe, Pt, B, Si and Ta can be used, and Co—Pt, Co—Cr, Co—Pt—Cr, Co—Pt—Cr—Ta and Co—Pt—Cr—B are particularly preferably used considering recording characteristics.

When the mixtures of cobalt-containing ferromagnetic metal alloys and nonmagnetic oxides are used, oxides of Si, Zr, Ta, B, Ti and Al can be used as the nonmagnetic oxides, and SiOₓ is most preferred taking recording characteristics into consideration. It is also possible to substitute these oxides with nitrides.

When a mixture of a cobalt-containing ferromagnetic metal alloy and a nonmagnetic oxide is used, the mixing ratio of cobalt-containing ferromagnetic metal alloy/nonmagnetic oxide is preferably from 95/5 to 80/20 (molar ratio), and particularly preferably from 90/10 to 85/15. When the ratio of a cobalt-containing ferromagnetic metal alloy is more than this range, magnetic particles cannot sufficiently separate from each other, so that the coercive force lowers. While when the ratio of a cobalt-containing ferromagnetic metal alloy is less than this range, the amount of magnetization decreases and signal output conspicuously lowers.

The thickness of a magnetic layer is preferably from 5 to 60 nm, more preferably from 10 to 25 nm. When the thickness is thicker than this range, noise increases conspicuously, and when thinner than this range, the output remarkably decreases.

A magnetic layer comprising a ferromagnetic metal alloy or a mixture of a ferromagnetic metal alloy and a nonmagnetic oxide can be formed by vacuum film-deposition methods, e.g., vacuum evaporation and sputtering. Of these methods, a sputtering method is preferably used in the invention for capable of forming a high quality and hyper thin film with ease. As a sputtering method, any of well-known DC sputtering methods and RF sputtering methods can be used in the invention. A web sputtering system of continuously forming a layer on a continuous film is preferably used, and a batch sputtering system and an in-line sputtering system as used in the manufacture of hard discs can also be used in the present invention.

General argon gases can be used as the gas in sputtering but other rare gases can also be used. A trace amount of oxygen gas may be introduced for the purpose of accelerating particle segregation of ferromagnetic metal alloy particles, or for adjusting the oxygen content of nonmagnetic oxides.

For forming a magnetic layer comprising a mixture of a ferromagnetic metal alloy and a nonmagnetic oxide by a sputtering method, it is possible to use two kinds of a ferromagnetic metal alloy target and a nonmagnetic oxide target and use a co-sputtering method of these two targets. However, for improving magnetic particle size variation to thereby form a uniform film, it is preferred to use an alloy target of a cobalt-containing ferromagnetic metal alloy and a nonmagnetic oxide. The alloy target can be manufactured by a hot press method.

A protective layer is provided for the purpose of preventing the corrosion of the metallic materials contained in a magnetic layer, and preventing the abrasion of a magnetic layer by the pseudo contact or contact sliding of a magnetic head and a magnetic disc, to thereby improve running durability and anticorrosion. Materials such as oxides, e.g., silica, alumina, titania, zirconia, cobalt oxide and nickel oxide, nitrides, e.g., titanium nitride, silicon nitride and boron nitride, carbides, e.g., silicon carbide, chromium carbide and boron carbide, and carbons, e.g., graphite and amorphous carbon can be used in a protective layer.

A protective layer is preferably a hard film having hardness equal to or higher than the hardness of the material of a magnetic head, and materials which hardly cause burning during sliding and stably maintain the effect are preferred, since such hard films are excellent in tribological durability. At the same time, materials having less pinholes are excellent in anticorrosion and preferred. As such a protective layer, hard carbon films called DLC (diamond-like carbon) manufactured by a CVD method and a reactive sputtering method are exemplified.

A protective layer may be formed by the lamination of two or more kinds of thin films having different properties. For example, it becomes possible to reconcile anticorrosion and durability on a high level by providing a hard carbon protective layer on the surface side for improving a tribological property and a nitride protective layer, e.g., silicon nitride, on the magnetic recording layer side for improving anticorrosion.

A lubricating layer is provided on a protective layer for the purpose of improving running durability and anticorrosion. Lubricants, e.g., well-known hydrocarbon lubricants, fluorine lubricants and extreme pressure additives, are used in a lubricating layer.

As hydrocarbon lubricants, carboxylic acids, e.g., stearic acid and oleic acid, esters, e.g., butyl stearate, sulfonic acids, e.g., octadecylsulfonic acid, phosphoric esters, e.g., monooctadecyl phosphate, alcohols, e.g., stearyl alcohol and oleyl alcohol, carboxylicacidamides, e.g., stearic acid amide, and amines, e.g., stearylamine, are exemplified.

The examples of fluorine lubricants include lubricants obtained by substituting a part or all of the alkyl groups of the above hydrocarbon lubricants with a fluoroalkyl group or a perfluoro polyether group. The examples of perfluoro polyether groups include a perfluoromethylene oxide polymer, a perfluoroethylene oxide polymer, a perfluoro-n-propylene oxide polymer (CF₂CF₂CF₂O)ₙ, a perfluoroisopropylene oxide polymer [CF(CF₃)CF₂O]ₙ, and copolymers of these polymers. Specifically, perfluoromethylene-perfluoroethylene copolymers having hydroxyl groups at molecular chain terminals (FOMBLIN Z-DOL, trade name, manufactured by Ausimont K.K.) are exemplified.

As extreme pressure additives, phosphoric esters, e.g., trilauryl phosphate, phosphorous esters, e.g., trilauryl phosphite, thiophosphorous esters, e.g., trilauryl trithiophosphite, thiophosphoric esters, and sulfur extreme pressure additives, e.g., dibenzyl disulfide, are exemplified.

These lubricants can be used alone or a plurality of lubricants can be used in combination. A lubricating layer can be formed by coating a solution obtained by dissolving a lubricant in an organic solvent on the surface of a protective layer by spin coating, wire bar coating, gravure coating or dip coating, alternatively depositing the solution on the surface of a protective layer by vacuum evaporation. The thickness of a lubricant is preferably from 0.1 to 3 nm, and particularly preferably from 0.5 to 2 nm.

It is preferred to use rust preventives in combination for bettering anticorrosion. As the examples of rust preventives, nitrogen-containing heterocyclic rings, e.g., benzotriazole, benzimidazole, purine and pyrimidine, derivatives obtained by introducing alkyl side chains to the mother nuclei of these nitrogen-containing heterocyclic rings, nitrogen- and sulfur-containing heterocyclic rings, e.g., benzothiazole, 2-mercaptobenzothiazole, tetraazaindene ring compounds, thiouracil compounds, and derivatives of these nitrogen- and sulfur-containing heterocyclic rings are exemplified. A rust preventive may be mixed with a lubricant and coated on a protective layer, alternatively a rust preventive may be coated on a protective layer prior to the coating of a lubricant, and then a lubricant may be coated thereon. The mixing ratio of a rust preventive in a lubricant is preferably from 0.01 to 100 mass % (weight %), particularly preferably from 0.1 to 50 mass %.

The flexible magnetic disc medium in the invention is characterized in that the ten point average roughness (Rz) of the surface of the medium at the side having a magnetic layer measured with an atomic force microscope (AFM) is from 15 to 40 nm, preferably from 17 to 30 nm, and the number of spines present at the height from the reference plane of 10 nm is from 0.1 to 10/μm².

An AFM is used in designing a surface property. Ten point average roughness (Rz) measured with an AFM is from 15 to 40 nm, and the number of spines present at the height from the reference plane of 10 nm is from 0.1 to 10/μm^{2.} A magnetic disc capable of being used in a high density commutable disc system using an MR head and a GMR head can be obtained by designing such a surface property.

To reduce Rz is effective to reduce spacing between a magnetic head and a magnetic disc, thereby it becomes possible to obtain sufficient recording/reproducing characteristics and recording resolution even in a region of high linear recording density of 200 kFCI or more. Further, the reduction of Rz leads to the prevention of breaking of an MR head and a GMR head. Rz is preferably smaller, preferably from 15 to 30 nm. Rz is evaluated by the ten point average roughness obtained by measuring the area of 30 μm×30 μm with an AFM. Measurement is preferably performed at three or more spots, preferably five or more spots.

On the other hand, the frictional force due to touching of a magnetic head and a magnetic disc can be reduced by restricting the number of spines present at the height from the reference plane of 10 nm to the range of the invention, thereby stable sliding becomes possible. Since a flexible magnetic disc rotates with keeping in contact with a head, the frictional force between a head and a magnetic disc becomes extraordinarily high if appropriate surface roughness is not provided, which causes breaking of the medium and the head, deterioration of error rate, and stoppage of an apparatus by the increase of the torque of a spindle. However, when high spines are provided for the purpose of reducing the frictional force of a head and a magnetic disc, spacing between a magnetic head and a magnetic disc increases, as a result high density recording becomes impossible. Accordingly, there are proper ranges of the height and density with spines, and it has been found that the number of spines present at the height from the reference plane of 10 nm is sufficient from 0.1 to 10/μm² in the AFM measurement.

The number of spines is specifically obtained by measuring an area of 30 μm×30 μm (900 μm²) by contact mode with ANOSCOPE III (manufactured by DIGITAL INSTRUMENT CORP.), taking the plane where the volumes of the concavities and convexities are equal as the reference plane, and counting the spines which are sliced when the plane 10 nm in height from the reference plane is sliced or spines being in contact with the sliced plane. That is, the number of spines used in the present invention is the number of spines having the height of 10 nm or higher from the reference plane per μm². The spines are preferably spines having a height from 10 to 30 nm from the reference plane, preferably from 10 to 20 nm.

There are cases where spines higher than the particles actually coated are present in a flexible magnetic disc having the above constitution of a ferromagnetic metal thin film as the magnetic layer, such that the agglomerates of minute spines coated on the surface of an undercoat layer are present if the coated state is left as it is. In some cases such defect not only causes the dropout and error of magnetic signals when low abrasive and high sensitivity heads, e.g., an MR head and a GMR head, are used, but also breaks these magnetic heads. In particular, in the case of a flexible magnetic system in which a magnetic disc and a head move in contact with each other, the influence of agglomerates is conspicuous. Accordingly, the dispersibility of fine particles is very important when minute spines are formed, and fine particles are required to be present completely free of agglomeration. For this purpose, it is preferred to use a silane coupling-agent as the dispersant of fine particles, or use organosilica sol dispersed in advance in a coating solvent. Further, with respect to a coating solvent also, by using a coating solvent having high affinity with the surface of an undercoat layer, agglomeration of fine particles due to drying nonuniformity can be prevented.

However, since it is actually difficult to completely prevent agglomeration of fine particles, it is preferred to use burnishing process with an abrasive tape in such a case or in cases where high spines are formed on the surface of a magnetic disc by other causes. As burnishing methods of hard disc type magnetic discs, burnishing processes of actually flying and running a burnishing head or a gliding head on magnetic discs are generally used, but since the flying amount of a burnishing head is not stable to perform burnishing process of a flexible magnetic disc by this method, it is difficult to process the entire surface of a magnetic disc with uniform accuracy.

As a burnishing method for obtaining the magnetic disc surface according to the invention, it is preferred to use a processing method of pressing an abrasive tape against the surface of a magnetic disc. For pressing an abrasive tape against the surface of a magnetic disc, it is effective to bring an abrasive tape along with a backup roller or a backup pad and get the magnetic disc and the abrasive tape into contact by making use of the regulating force of the backup roller or backup pad. Since a flexible magnetic disc is easily deformed by the pressing of an abrasive tape, it is preferred that the regulating members be pressed also from the opposite side, it is more preferred that both surfaces of a flexible magnetic disc be processed at the same time in the same manner as above by bringing an abrasive tape along with a backup roller or backup pad and pressing against a magnetic disc. It is also possible to press a disc against an abrasive tape by air from the opposite side, but contaminations may be adhered on the disc by the air, so that it is preferred to provide a counter measure in the apparatus.

Well-known backup rollers and backup pads can be used in the invention.

The pressure of pressing an abrasive tape is preferably from50 to200 gf/cm (from 49 to 196 N/m). By setting the pressure in this range, burnishing effect can be ensured and generation of scratches on a magnetic disc by processing is inhibited, although it depends upon the kind of an abrasive tape. Appropriate burnishing processes are described in detail later.

The feed velocity of an abrasive tape is preferably from 10 to 100 mm/min for the reasons that the chips by processing hardly adhere on the abrasive tape, so that scratches by processing are hardly generated, and the consumption of the abrasive tape can be suppressed.

The rotation speed of a magnetic disc is preferably from 500 to 3,000 rpm for the reasons that scratches by processing are hardly generated, the rotation of a magnetic disc is stable and processing uniformity can be obtained.

When the breadths of an abrasive tape and a magnetic disc to be processed are the same or an abrasive tape is broader than a magnetic disc, burnishing process can be performed without moving the abrasive tape and the magnetic disc in relation to the other, but when the breadth of an abrasive tape is narrower than the breadth of a magnetic disc to be processed, process is performed by moving the position of the abrasive tape to the magnetic disc to secure the processing breadth. At this time, a manner of pulling the abrasive tape from the innermost periphery to the outer periphery of the processing position is most preferred. The pulling velocity is preferably from 50 to 700 mm/sec for the reasons that the processing scratches are hardly generated and burnishing effect can be ensured. It is also possible to take the processing direction from the outer periphery toward the inner periphery, but rotation is liable to be labile in the case of a flexible magnetic disc.

As the abrasive tapes, abrasive tapes for highly accurate processing having particle sizes of No. 10000 or higher can be used. As the abrasives for use in the abrasive tapes, diamond, alumina, chromium oxide and iron oxide are exemplified. These abrasives are dispersed in a solvent with a resin binder, and the dispersion is coated on a flexible support, dried, cut to a desired breadth and used as an abrasive tape. At this time, if necessary, a curing agent, a lubricant and a dispersant can be used in addition to an abrasive and a resin binder.

### EXAMPLES

The novel effect of the invention is further described with reference to the following examples.

### Examples 1 to 8 and Comparative Examples 1 and 2

An undercoat layer coating solution comprising 3-glycidoxypropyltrimethoxysilane, phenyltriethoxysilane, hydrochloric acid, aluminum acetylacetonate and ethanol was coated on a polyethylene naphthalate film having a thickness of 52 μm and surface roughness Ra of 1.4 nm by gravure coating, and the coated solution was subjected to drying and curing at 100° C., thereby an undercoat layer having a thickness of 1.0 μm comprising a silicone resin was formed. A solution comprising silica sol having a particle size of 12 nm, 18 nm or 25 nm as shown in Table 1 below having been dispersed in cyclohexane was coated on the undercoat layer by gravure coating, thereby spines were formed on the surface of the undercoat layer. The number of spines was adjusted by changing the concentration of silica sol in each coating solution. The undercoat layer was formed on both sides of the support film. The web was mounted on a web sputtering system and the following layers were formed on the undercoat layer by a DC magnetron sputtering method by moving the web with keeping in contact with a can cooled at 15° C. with water: a gas barrier layer comprising C having a thickness of 20 nm, an under layer comprising Ru having a thickness of 30 nm, a magnetic layer comprising (Co₇₀—Pt₂₀—Cr₁₀)₈₈—(SiO₂)₁₂ having a thickness of 20 nm, and a protective layer comprising C having a thickness of20nm. These under layer, magnetic layer and protective layer are formed on both sides of the support film. Subsequently, a lubricating layer having a thickness of 1 nm was formed on the surface of the protective layer by coating a solution obtained by dissolving a perfluoro polyether lubricant having hydroxyl groups at the molecule terminals (FOMBLIN Z-DOL, manufactured by Montefluos Co.) in a fluorine lubricant (HFE-7200, manufactured by Sumitomo 3M Limited) by gravure coating. The lubricating layer was also formed on both sides of the film. In the next place, a 2.5 inch size magnetic disc was punched out of the web. Both surfaces of the disc were subjected to burnishing process at the same time with a No. 30000 alumina abrasive tape having a breadth of ½ inches and the magnetic disc was built in a metal cartridge, thereby a flexible magnetic disc medium was obtained, provided that a magnetic disc medium in Comparative Example 1 was prepared without being subjected to burnishing process.

Each of the obtained samples was evaluated as follows, and the results obtained are shown in Table 1 below.

(1) Rz and Number of Spines

Five spots in the area of 30 μm×30 μm of the surface of each magnetic disc were measured with an AFM, and the ten point average roughness Rz at each measured spot was obtained. The average value was taken as Rz. The number of spines at the height from the reference plane of 10 nm in the same area was examined.

(2) Frictional Force, SNR and PW50

Recording and reproduction of linear recording density of 200 kFCI were performed with a GMR head of reproducing track breadth of 0.28 μm and recording track breadth of 0.44 μm, and reproducing signal/noise ratio (SNR) was measured. At this time, the integration of noise was until 400 kFCI, the rotation of the magnetic disc was 4,200 rpm, the position of radius was 25.4 mm, and the load of head was 1 gf (9.8 mN). The resolution of recording was evaluated from the half value width PW50 of solitary inverted waveform. The frictional force applied to the head was measured with a strain gauge in the same system of measurement under the same condition.

TABLE 1

| | | | Number | | | | | |
|---|---|---|---|---|---|---|---|---|
| | | | of | | | | | |
| | Silica | | Spines | | | | | |
| | Sol | | (num- | Frictional | | | | |
| Example | Coated | Rz | ber/ | Force | | SNR | PW50 | |
| No. | (nm φ) | (nm) | μm²) | gf | mN | (dB) | μinch | μm |
| Example 1 | 18 | 25 | 1 | 0.3 | 2.94 | 19.8 | 5.6 | 0.142 |
| Example 2 | 18 | 24 | 0.5 | 0.4 | 3.92 | 19.9 | 5.5 | 0.140 |
| Example 3 | 18 | 27 | 3 | 0.3 | 2.94 | 19.5 | 5.6 | 0.142 |
| Example 4 | 18 | 27 | 10 | 0.3 | 2.94 | 19.0 | 5.7 | 0.145 |
| Example 5 | 25 | 29 | 3 | 0.3 | 2.94 | 19.1 | 5.7 | 0.145 |
| Example 6 | 25 | 33 | 1 | 0.3 | 2.94 | 18.8 | 5.9 | 0.150 |
| Example 7 | 12 | 21 | 3 | 0.4 | 3.92 | 19.8 | 5.5 | 0.140 |
| Example 8 | 12 | 20 | 0.5 | 0.5 | 4.90 | 19.8 | 5.5 | 0.140 |
| Comparative | 18 | 55 | 1 | 0.3 | 2.94 | 18.5 | 6.2 | 0.157 |
| Example 1 | | | | | | | | |
| Comparative | 12 | 20 | 0.05 | 1.2 | 11.76 | 18.1 | 7.2 | 0.183 |
| Example 2 | | | | | | | | |

From the results shown in Table 1, it can be seen that the samples according to the invention are low in frictional force, high in SNR, low in PW50 and excellent in the resolution of recording. The sample in Comparative Example 1 is high in Rz as compared with the samples according to the invention, and inferior in SNR and PW50. The sample in Comparative Example 2 is less in the number of spines than the samples of the invention, high in frictional force and inferior in SNR and PW50.

The present invention can provide inexpensively a magnetic disc capable of high density recording by which the impact by the touch of a magnetic head and a magnetic disc is reduced, stable head running is possible by the specific surface characteristics, long term operation is possible without breaking the heads even when an MR head and a GMR head that are low abrasion resistant and high sensitivity magnetic heads are used, and high performance and highly reliability can be ensured.

This application is based on Japanese Patent application JP 2003-163872, filed Jun. 9, 2003, the entire content of which is hereby incorporated by reference, the same as if set forth at length.

What is claimed is:

1. A magnetic disc medium comprising a flexible polymer support and a magnetic layer containing a ferromagnetic metal, wherein a ten point average roughness of a surface of the magnetic disc medium of a side having the magnetic layer measured with an atomic force microscope is from 15 to 40 nm, and a number of projections present at a height from a reference plane of 10 nm on the surface is from 0.1 to 10/μm².

2. The magnetic disc medium according to claim 1, wherein the magnetic layer contains a ferromagnetic metal alloy containing a cobalt.

3. The magnetic disc medium according to claim 1, wherein the magnetic layer contains a ferromagnetic metal alloy containing a cobalt, and a nonmagnetic oxide.

4. The magnetic disc medium according to claim 1, wherein a particle size of the ferromagnetic metal alloy is from 1 to 50 nm.

5. The magnetic disc medium according to claim 1, wherein the ferromagnetic metal alloy contains Co and at least one of Cr, Ni, Fe, Pt, B, Si and Ta.

6. The magnetic disc medium according to claim 2, wherein the ferromagnetic metal alloy is an alloy containing Co and Pt, an alloy containing Co and Cr, an alloy containing Co, Pt and Cr, an alloy containing Co, Pt, Cr and Ta, or an alloy containing Co, Pt, Cr and B.

7. The magnetic disc medium according to claim 3, wherein the nonmagnetic oxide contains Si, Zr, Ta, B, Ti or Al.

8. The magnetic disc medium according to claim 3, wherein the nonmagnetic oxide is an oxide of Si.

9. The magnetic disc medium according to claim 3, wherein the ferromagnetic metal alloy is an alloy containing Co, Pt and Cr, the nonmagnetic oxide is SiO₂, and the magnetic disc medium further comprises an under layer containing Ru.

10. The magnetic disc medium according to claim 3, wherein the ferromagnetic metal alloy is an alloy containing Co, Pt and Cr, the nonmagnetic oxide is SiO₂, and the magnetic disc medium further comprises a gas barrier layer containing C, an under layer containing Ru, a protective layer containing C and a lubricating layer containing a fluorine lubricant so that the support, the gas barrier layer, the under layer, the magnetic layer, the protective layer and the lubricating layer are in this order.

11. The magnetic disc medium according to claim 1, wherein the magnetic layer has a thickness of from 5 to 60 nm.

12. The magnetic disc medium according to claim 1, wherein the magnetic layer has a thickness of from 10 to 25 nm.

13. The magnetic disc medium according to claim 1, further comprising an undercoat layer so that the flexible polymer support, the undercoat layer and the magnetic layer are in this order, wherein the undercoat layer contains at least one of a polyimide resin, a polyamideimide resin, a silicone resin and a fluorine resin.

14. The magnetic disc medium according to claim 1, further comprising an undercoat layer so that the flexible polymer support, the undercoat layer and the magnetic layer are in this order, wherein the undercoat layer contains a thermosetting polyimide resin or a thermosetting silicone resin.

15. The magnetic disc medium according to claim 1, further comprising an under layer so that the flexible polymer support, the under layer and the magnetic layer are in this order, wherein the under layer contains at least one member selected from the group consisting of Cr, alloys of Cr with a metal selected from Ti, Si, W, Ta, Zr, Mo and Nb, and Ru.

16. The magnetic disc medium according to claim 1, further comprising a protective layer so that the flexible polymer support, the magnetic layer and the protective layer are in this order, wherein the protective layer contains at least one of silica, alumina, titania, zirconia, cobalt oxide, nickel oxide, titanium nitride, silicon nitride, boron nitride, silicon carbide, chromium carbide, boron carbide, graphite, and amorphous carbon.
